(19) United States
(12) Patent Application Publication
(10) Pub. No.: US 2004/0243037 A1
(43) Pub. Date: Dec. 2, 2004

(54) Device for massaging and liquid treatment

(76) Inventors: Thelma Janette Zapalac, Livingston, TX (US); Eli Zhadanov, Brooklyn, NY (US); Sam Zhadanov, Brooklyn, NY (US)

Correspondence Address: Ilya Zborovsky, 6 Schoolhouse Way, Dix Hills, NY, 11746, US

(21) Appl. No.: 10/446,237

(22) Filed: May 29, 2003

(51) Int. Cl. A61H 7/00

(52) U.S. Cl. 601/155; 601/169

(57) ABSTRACT

A device for massaging and liquid treatment has a massaging element provided with a plurality of massaging projections and a liquid outlet, and a liquid supplying element connectable to a source of liquid and cooperating with the massaging element so as to supply liquid through the massaging element and to the outlet to be issued from the outlet, so that a user can hold the device between two fingers of a hand, and during treatment the massaging element freely turns relative to the liquid supplying element.

### BACKGROUND OF THE INVENTION

The present invention relates to devices for massaging and liquid treatment.

Devices of the above mentioned general type are known in the art, some of such devices are disclosed in U.S. Pat. Nos. 1,840,812; 2,678,457; 3,431,573; 4,089,079; 4,155,137; and 5,678,258. It is believed that the existing devices of the above mentioned general type can be further improved.

### SUMMARY OF THE INVENTION

Accordingly, it is an object of the present invention to provide a device for massaging and liquid treatment, which is a further improvement of the existing devices.

It is another object of the present invention to provide a device for massaging and liquid treatment which allows a very simple and easy handling by a user of the device during corresponding treatment, for example during treatment of body parts, and in particular during treatment of a head and the like.

It is still a further feature to provide a device for massaging and liquid treatment which not only involves easly handling of the device during the process of performing a corresponding treatment, but also provides a very efficient treatment of corresponding surfaces, for example surfaces of body parts, such as a head and the like.

In keeping with these objects and with others which will become apparent hereinafter, one feature of the present invention resides, briefly stated, in a device for massaging and liquid treatment, comprising a massaging element provided with a plurality of massaging projections and a liquid outlet; and a liquid supplying element connectable to a source of liquid and cooperating with said massaging element so as to supply liquid through said massaging element and to said outlet to be issued from said outlet, wherein so that a user can hold the device between two fingers and said massaging element is turnable relative to said liquid supplying element.

When the device for massaging and liquid treatment is designed in accordance with the present invention, a user can hold the massaging device by a hand and move it freely along a surface to be treated, for example a surface of a body part such as a head and the like, since the massaging element is freely turnable relative to the liquid supplying element, and therefore liquid is applied onto a corresponding body part and at the same time the projections of the massaging element perform the massaging action, and also the device is conveniently held between two finger of the user's hand.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross section of a device for massaging a liquid treatment in accordance with the present invention;

FIG. 2 is a view from below of the inventive device for massaging and liquid treatment; and

FIG. 3 is a view showing a user's hand operating the inventive device for massaging and liquid treatment.

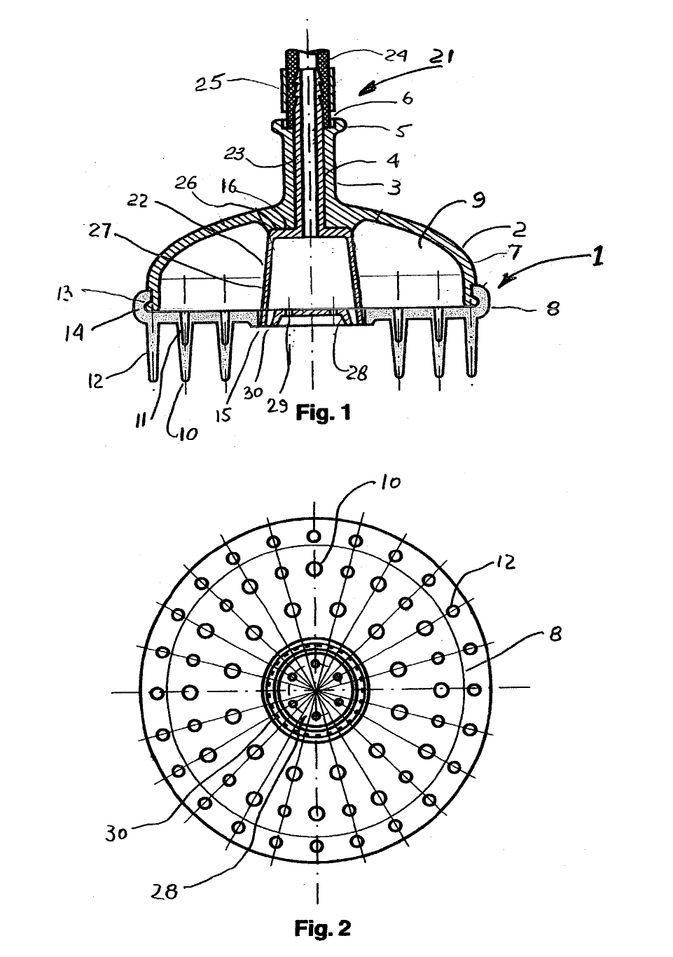

### DESCRIPTION OF THE PREFERRED EMBODIMENTS

A device for massaging and liquid treatment in accordance with the present invention has a massaging element which is identified as a whole with reference numeral 1, and a liquid supplying part which is identified as a whole with reference numeral 21.

The massaging element 1 has a main part 2 and a tubular part 3 which extends from the main part 2 and is located upstream of the main part 2 as considered in direction of flow of liquid. The tubular part 3 has an inner passage 4 and at its upstream end is provided with a flange 5 having a groove 6. The main part 2 of the massaging element 1 has a first wall portion 7 located upstream, and a second wall portion 8 located downstream. The first wall portion 7 and the second wall portion 8 together define an inner space 9. The first wall portion 7 has a substantially curved shape, for example a bell shape, so that it can be conveniently held in a palm of a user's hand. The second wall portion 8 is provided with a plurality of massaging projections.

At least some of the massaging projections identified with reference numeral 10 are elastic and flexible so as to provide a corresponding massaging action. The massaging projections 10 can be provided with inner hollows 11 so as to enhance their flexibility. Other massaging projections identified with reference numeral 12 can be less flexible, and as can be seen from the drawings, they are not provided with inner hollows, so that they produce a different massaging action.

The wall portions 7 and 8 of the main part 2 of the massaging element 1 are releasably connected with one another by correspondingly formed connecting means. The connecting means in the shown embodiment include a peripheral depression 13 formed in a lower area on an outer surface of the first wall portion 7, and a peripheral projection 14 provide on the second wall portion and formed substantially hook-shaped so as to engage in the peripheral depression 13 of the first wall portion 7 of the main part 2 of the massaging element 1. The lower area of the first wall portion 7 provided with the peripheral depression 13 and/or the peripheral projection 14 can be formed yieldable so as to provide the interengagement of the peripheral projection 14 and the peripheral depression 13 in a springy manner, with a snap action.

The second wall portion 8 can be formed as a disposable element, so that after treatment or a corresponding number of treatments of body parts, for example after treatment of a head with the inventive device, the second wall portion 8 can be removed and discarded, and another similar wall portion 8 can be attached to the first wall portion 7 of the main part 2 of the massaging element 1. It is possible that the first wall portion 7 of the main part 1 together with the tubular part 4 of the massaging element is composed of one material, while the second wall portion 8 is composed of another less costly material, to allow inexpensive discarding of the second wall portion 8.

The main part 2 of the massaging element 1 further has an outlet which is identified with reference numeral 15 and provided centrally in the wall portion 8. The main part 2 of the massaging element 1 further has a substantially straight transverse supporting surface identified with reference numeral 16.

The liquid supplying element 21 of the inventive device for massaging and liquid treatment has a main portion which is identified with reference numeral 22 and a tubular portion 23 extending from the main portion 22 and located upstream of the latter. The tubular portion 23 extends through the passage 4 of the tubular part 3 of the massaging element 1, so that the tubular part 3 of the massaging element 1 is rotatable relative to the tubular portion 23 of the liquid supplying element 21 and vice versa, and therefore the massaging element 1 as a whole is turnable relative to the liquid supplying element 21. The tubular portion 23 of the liquid supplying element 21 is connectable to a source of liquid for example by a hose 24 having a lower end introduced into the groove 6, fitted on an end part of the tubular portion 23 and fixed by a clamp 25.

The main portion 22 of the liquid supplying element has a transverse end wall 26 which abuts against the transverse supporting surface 16 of the main part 2 of the massaging element 1 for stabilizing purposes. The main portion 22 further has a peripheral wall 27 located inside the main part 2 of the massaging element 1 and having a lower portion which is rotatably arranged in the outlet 15 of the main part 2 of the massaging element 1. The peripheral wall 27 is substantially conical so as to spread a flow of liquid. The main portion 22 of the liquid supplying element 21 further has another end wall 28 located downstream of the end wall 26.

The end wall 28 is provided with a plurality of throughgoing openings as shown in particular in FIG. 2. The throughgoing openings of the end wall 28 include a plurality of central openings which are identified with reference numeral 29 and also peripheral openings which are identified with reference numeral 30. The central openings 29 can be formed as straight openings extending parallel to an axis of the device, while the peripheral openings 30 can be inclined relative to the axis of the device and formed between the end wall 28 and the peripheral wall 27, for spreading the flow of liquid over a greater area.

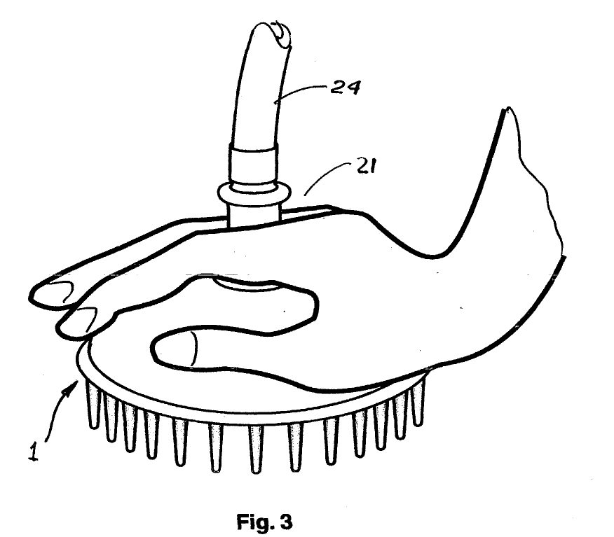

One of the important features of the present invention is that the tubular part 3 of the massaging element 1 through which the tubular portion 23 of the liquid supplying element 21 passes, has an outer size or a diameter which is so small that the tubular part 3 can be accommodated between a pointing finger and a middle finger of the user as shown in particular in FIG. 3, when a palm of the user is placed on an outer surface of the main part 2 of the massaging element 1. With this construction, the device can be easily held by the user and leave its other fingers and a thumb free. For example, the outer diameter of the tubular part 3 of the massaging element can be within 1/2-3/4 inches.

The device in accordance with the present invention operates in the following manner.

A user holds the device by applying a palm of his hand on the outer surface of the main part 2 of the massaging element 1 and holding the tubular part 3 of the massaging element 1 between his or her two fingers, liquid such as for example water, water with a cleaning solution, etc., is supplied through an interior of the tubular portion 23 of the water supplying element 21 and exits through the openings 29 and 30 onto a surface to be treated, for example onto a surface of a body part, such as a head and the like, and the user moves the whole device along the surface. During this movement the massaging element 1 is freely turnable relative to the liquid supplying element 21, in particular around an axis A which is a common axis of the massaging element 1 and a liquid supplying element 21.

It will be understood that each of the elements described above, or two or more together, may also find a useful application in other types of constructions differing from the types described above.

While the invention has been illustrated and described as embodied in device for massaging and liquid treatment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for massaging and liquid treatment, comprising a massaging element provided with a plurality of massaging projections and having a liquid outlet; and a liquid supplying element connectable to a source of liquid and cooperating with said massaging element so as to supply liquid through said massaging element and to said outlet, said massaging element being turnable relative to said liquid supplying element during operation.

2. A device for massaging as defined in claim 1, wherein said massaging element and said liquid supplying element have a common axis, said massaging element being turnable relative to said supplying element around said axis.

3. A device as defined in claim 1, wherein said massaging element has a main part formed so as to be held by a palm of the user and an upstream part, as considered in direction of flow of liquid, which extends from said main part and is tubular, said liquid supplying element having a tubular portion extending through said tubular part of said massaging element, said tubular part of said massaging element being turnable relative to said tubular portion of said water supplying element.

4. A device as defined in claim 1, wherein said liquid supplying element has a main portion located inside said massaging element and having an inner chamber and a plurality of outlet openings communicating with said outlet of said massaging element.

5. A device as defined in claim 4, wherein said main portion of said liquid supplying element has a peripheral wall, a first end wall located upstream in direction of flow of liquid, and a second wall located downstream in direction of flow of liquid, said second end wall being provided with said outlet openings.

6. A device as defined in claim 5, wherein said outlet openings include a first group of said openings located substantially in a central area of said second end wall, and a second group of openings located in a peripheral area of said second end wall.

7. A device as defined in claim 6, wherein said second outlet openings are formed as channels provided between said second end wall and said peripheral wall of said liquid supplying element.

8. A device as defined in claim 7, wherein said massaging element and said liquid supplying element have a common axis, said channels being inclined relative to said axis.

9. A device as defined in claim 1, wherein at least some of said projections of said massaging element are substantially flexible.

10. A device as defined in claim 9, wherein said flexible projections of said massaging element are hollow so as to enhance their flexibility.

11. A device as defined in claim 1, wherein said massaging element has a main portion and a tubular portion extending from said main part and located upstream of the latter as considered in direction of flow of liquid, said liquid supplying element having a main portion located inside said main part of said massaging element and a tubular portion extending through said tubular part of said massaging element, said tubular part of said massaging element having a diameter allowing holding of said tubular part of said massaging element between two fingers of a user's hand.

12. A device as defined in claim 10, wherein said tubular part of said massaging element has an outer diameter substantially equal to 1/2-¾.

13. A device as defined in claim 1, wherein said massaging element has a main part provided with said projections and a tubular part extending from said main part and located upstream of said main part as considered in direction of flow of liquid, said liquid supplying element having a main portion located inside said massaging element and forming an inner chamber and a tubular portion extending from said main portion and located inside said tubular part of said massaging element, said main portion of said liquid supplying element having a substantially conical peripheral wall.

14. A device as defined in claim 1, wherein said massaging element has a main part provided with said projections and a tubular part extending from said main part and located upstream of said main part as considered in direction flow of liquid, said liquid supplying element having a main portion forming an inner chamber and a tubular portion extending from said main portion and located in said tubular part of said massaging element, said main part of said massaging element having an inner transverse supporting surface, said main portion of said liquid supplying element having an end wall abutting against said transverse supporting surface of said main part of said massaging element.

15. A device as defined in claim 1, said massaging element has a first wall portion and a second wall portion, said second wall portion being provided with said projections and being removably connectable with said first wall portion.

16. A device as defined in claim 14, wherein said second wall portion provided with said projections is formed as a disposable portion, which can be removed from said first wall portion of said massaging element and replaced with another such second wall portion.

17. A device as defined in claim 15; and further comprising means for connecting said first wall portion and said second wall portion of said massaging element removably with one another.

18. A device as defined in claim 17, wherein said connecting means include a peripheral outer depression provided in said first wall portion of said massaging element, and a peripheral projection provided in said second wall portion of said massaging element and engageable in said peripheral depression with a spring action.
